(19) United States
(12) Patent Application Publication
(10) Pub. No.: US 2005/0049450 A1
(43) Pub. Date: Mar. 3, 2005

(54) Melting plasma method for treatment of Alq3 organic waste

(76) Inventors: Yu-Ting Shen, Tainan Hsien (TW); Chun-Liang Lai, Chiayi Hsien (TW); Ling Lu, Taoyuan Hsien (TW); Chan-Yi Chen, Tainan Hsien (TW); Chang-Lung Hsieh, Chungho City (TW); Chi-Ho Fu, Hsintien City (TW); Bun-Ching Liu, Taipei (TW); Fu-Chen Liu, Hualien Hsien (TW); Chen-Lin Huan, Kaohsiung Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/650,705

(22) Filed: Aug. 29, 2003

(51) Int. Cl. A62D 3/00

(52) U.S. Cl. 588/311

(57) ABSTRACT

A melting plasma method for treatment of Alq3 organic waste has steps of (a) providing an organic waste comprising Alq3; (b) heating the Alq3 organic waste provided in step (a) by melting plasma; and (c) obtaining a non-toxic organic solid lava which does not have any Alq3.

### BACKGROUND OF THE INVENTION

1. Field of the Invention

The present invention relates to a melting plasma melting method, and more particularly to a melting plasma method for treatment of an organic waste. More particularly, the organic waste comprises tris-(8-hydroxyquinolinato) aluminum (Alq3).

2. Description of Related Art

Organic electroluminescent materials such as tris-(8-hydroxyquinolinato) aluminum (Alq3) are particularly suitable for flat panel displays and are used extensively in the fabrication of organic light-emitting diodes (OLED). However, Alq3 is difficult to break down so. Alq3 is classified as uncombustible organic waste. Most combustible wastes are disposed of by burning in an incinerator. However, the uncombustible waste burns incompletely so burning uncombustible waste will produce toxic gases and pollute the environment. Since treatment of uncombustible waste is difficult and complicated, a method for treatment of uncombustible. Alq3 organic waste is very important.

### SUMMARY OF THE INVENTION

The main objective of the present invention is to provide a convenient and non-toxic method to treat. Alq3 organic waste.

To achieve the objective, a melting plasma method for treatment Alq3 organic waste in accordance with the present invention has steps of providing an organic waste comprising Alq3, heating the Alq3 organic waste by melting plasma and forming a non-toxic organic lava by melting the residual organic waste material without any Alq3. Preferably, the Alq3 organic waste is placed in a reaction device and heated by melting plasma in the reaction device. More preferably, the Alq3 organic waste is heated by the melting plasma to over 1300° C. in one hour. The method breaks down the Alq3 completely and does not produce toxic gas or pollute the environment.

Further benefits and advantages of the present invention will become apparent after a careful reading of the detailed description with appropriate reference to the accompanying drawings.

### BRIEF DESCRIPTION OF THE DRAWINGS

FIG. 1 is a picture of a residual Alq3 sample initially composed of waste glass, waste soil and Alq3 in a ratio of 7:10:3 after heating with melting plasma;

FIG. 2 is a picture of a residual Alq3 sample initially composed of waste glass and Alq3 in a ratio of 17:3 after heating with melting plasma;

FIG. 3 is a XRD analysis diagram of a residual Alq3 sample initially composed of waste glass, waste soil and Alq3 in a ratio of 7:10:3 after heating with melting plasma;

FIG. 4 is a XRD analysis diagram of a residual Alq3 sample initially composed of waste glass and Alq3 in a ratio is 17:3 after heating with melting plasma;

FIG. 5 is an EDS analysis diagram of a residual Alq3 sample initially composed of waste glass, waste soil and Alq3 in a ratio is 7:10:3 after heating with melting plasma;

FIG. 6 is a HPLC analysis diagram of an Alq3 sample before heating with melting plasma;

FIG. 7 is a HPLC analysis diagram of a residual Alq3 sample initially composed of waste glass, waste soil and Alq3 in a ratio of 7:10:3 after heating with melting plasma; and

FIG. 8 is a HPLC analysis diagram of a residual Alq3 sample initially composed of waste glass and Alq3 in a ratio of 17:3 after heating with melting plasma.

### DETAILED DESCRIPTION OF THE INVENTION

The present invention provides a melting plasma method for treatment of an Alq3 organic waste and product will be non-toxic.

Plasma is a highly ionized gas and is also a collector of molecules, atoms, electrons and ions. Plasma is different from a gas and is considered to be a fourth state of mass.

Melting plasma is a clear heat source not needed burning. The process of using melting plasma to treat waste is an energy conversion and transfer phenomenon. When an active ingredient of the melting plasma decays and produces energy, the energy will be transferred to the waste exposed to the melting plasma. When the waste interacts with the energy, the waste will be atomized and ionized, will decay and finally completely destroyed. The significant principle in using melting plasma to treat organic waste is the fact that melting plasma destroys the bond between the elements comprising the organic waste.

The melting plasma method to treat waste produces simple molecules or atoms like hydrogen, carbon monoxide, carbon, hydrogen chloride and the like. The process does not allow big or complicate molecules to reform so the melting plasma method is very safe and non-polluting.

The melting plasma method has the following characteristics.
(1) The melting plasma directly heats the waste, and heat loss is minimized.
(2) The treatment processing can be performed under different conditions (for example, air or nitrogen gas) so the melting plasma method can include specific chemical reactions that cannot be done in an incinerator. For example, organic material can be destroyed in an inert gas, and metal oxide can be efficiently reduced to reductive metal in reduction condition.
(3) The melting plasma can burn material completely. The melting plasma method does not need a pre-treatment step and can decrease contact with humans and the treatment cost.
(4) The melting plasma method exhausts less and produces less airborne solids so the exhaust system will be simple.

The melting plasma method for treatment of Alq3 organic waste in accordance with the present invention comprises the following steps.
(a) An organic waste comprising Alq3 is provided.
(b) The organic waste comprising Alq3 is heated by melting plasma.
(c) A non-toxic organic solid lava that does not have any Alq3 is obtained.

Preferably, the organic waste comprising Alq3 provided in step (a) is placed in a reaction device and then heated by melting plasma in the reaction device.

In step (b), the Alq3 organic waste is heated by melting plasma to over 1300° C. in one hour.

In a preferred embodiment, an organic waste comprising Alq3, waste soil and waste glass is heated by melting plasma to over 1300° C. and produces a vitrescent lava. The Alq3 is ionized by heating with melting plasma and produces a simple gas composed of carbon, hydrogen and oxygen, for example, water or carbon dioxide. When the vitrescent lava is cold, the vitrescent lava is assayed including composition analysis, crystal structure analysis and residual analysis. The composition analysis is assayed by Energy Dispersive Spectrometers (EDS) to test the element composition. The result is that most of the product is from the original waste soil and waste glass. The crystal structure analysis is assayed by X-ray diffractometer (XRD), and the result shows that the product is a vitrescent structure. The residual analysis is assayed by High Performance Liquid Chromatography (HPLC), and the results show that the product has no Alq3 peak.

Accordingly, the melting plasma method for treatment of Alq3 organic waste in accordance with the present invention has the following characteristics. The present method can completely treat Alq3, and no residual Alq3 is in the product. Compared with the conventional incinerating method, the present method produces solid lava so the chemical properties of the product are stable. The present method solves the problems with the treatment of Alq3.

Further details of this invention are illustrated in the following examples.

### EXAMPLES

### Example 1: An Alq3 Sample Treated with Melting Plasma

An Alq3 sample composed of different quantities of Alq3, waste soil and waste glass was heated to 1300° C. or 1459° C. in one hour. The melting plasma provided a 100 KW heat source that was mounted in a reaction device. The maximum temperature of the heat source is over 10,000° C., and the electronic density was over 1×10¹⁶#/cm³. The mediator of the melting plasma was air. In the process, the temperature and the persistence were controlled by regulating direct current and the amount of gas. In the example, the temperature rate was 7° C./min. The reaction device was composed of 10% CrO₄ and 90% AlO₃ and the temperature in the reaction device was distributed uniformly.

### Example 2

### Appearance of the Alq3 Sample after Treatment with Melting Plasma

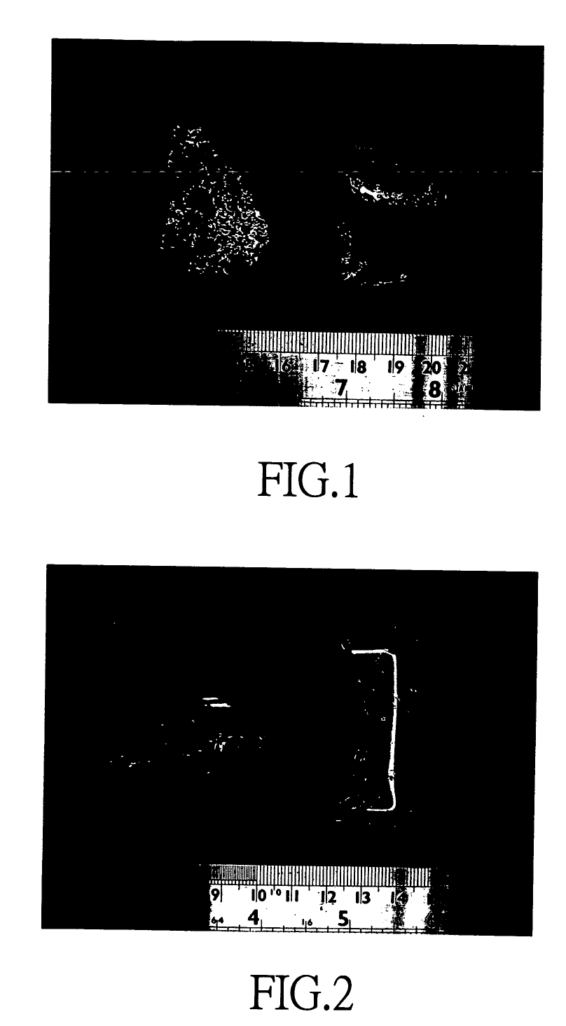

When the resultant product provided in example 1 cooled, the product appearance was observed. With reference to FIG. 1, the ratio of the untreated Alq3 sample composed of waste glass, waste soil and Alq3 was 7:10:3. The appearance of the product was completely vitrescent. With reference to FIG. 2, the ratio of the untreated Alq3 sample composed of waste glass and Alq3 was 17:3. The appearance of the product was completely vitrescent.

### Example 3

### Copper Target X-ray Diffractometer (XRD) Assay Analysis the Alq3 Sample Treatment with Melting Plasma

The product produced by example 1 was analyzed by copper target XRD assay (λ=1.5406 Å) to determine the crystal structure of the product.

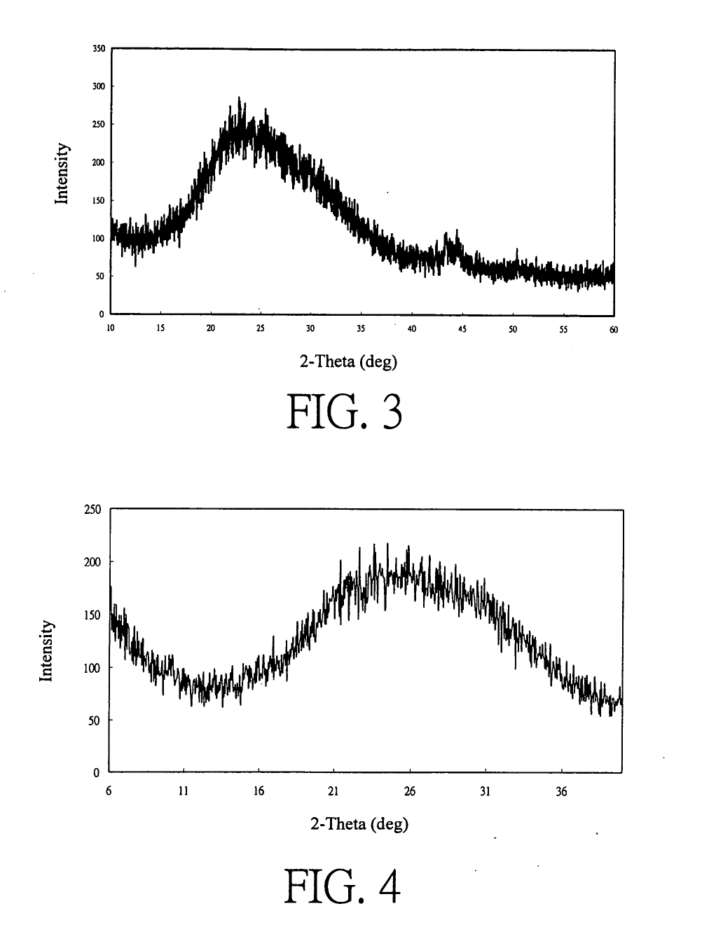

The test sample was produced by pulverizing the product. The powder sample was used to determine the crystal structure by XRD assay. With reference to FIG. 3, the ratio of the untreated Alq3 sample composed of waste glass, waste soil and Alq3 was 7:10:3. With reference to FIG. 4, the ratio of the untreated Alq3 sample composed of waste glass and Alq3 was 17:3. These results show that the Alq3 sample heated by melting plasma formed a vitrescent structure.

### Example 4

### Energy Dispersive Spectrometer (EDS) Assay Analysis of the Alq3 Sample Treated by Melting Plasma

The product produced by example 1 was analyzed by an Energy Dispersive Spectrometer (EDS) assay to determine the elemental composition of the product.

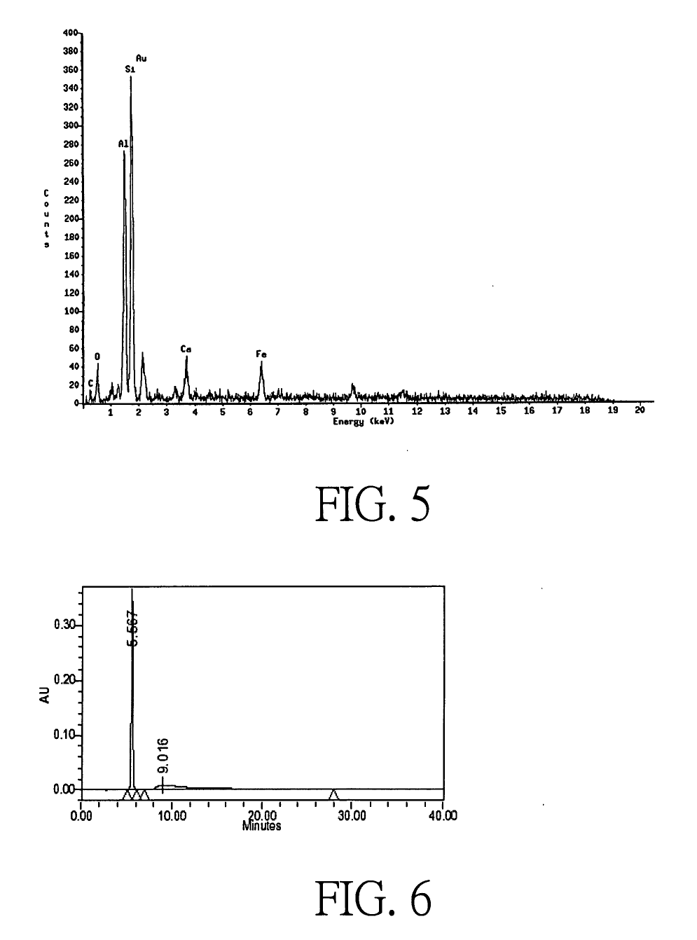

An EDS test sample was produced by taking a 2 cubic centimeter product and fixing the product by adding hardener and mounting powder. After the product was hardened, a slow rate Diamond Abrasive Cutting Machine cut the product to produce a plane that was polished. Finally, the test sample was plating an Au layer to let the test sample conduct electricity. With reference to FIG. 5, the main components of the product were O, Al, Si, Ca, Au and Fe. Almost all the components belong to the original waste soil and waste glass.

### Example 5

### High Performance Liquid Chromatography (HPLC) Assay Analysis of the Alq3 Sample Treated by Melting Plasma

The product produced by example 1 was analyzed by HPLC to determine the residual composition of the product.

With reference to FIG. 6, the results of the analysis of an Alq3 sample before heating with melting plasma by HPLC respectively showed a peak present at 5.567 and 9.016 minutes. The results of the assay is used as a standard reference to determine whether the treated sample heated with melting plasma contains Alq3 or not.

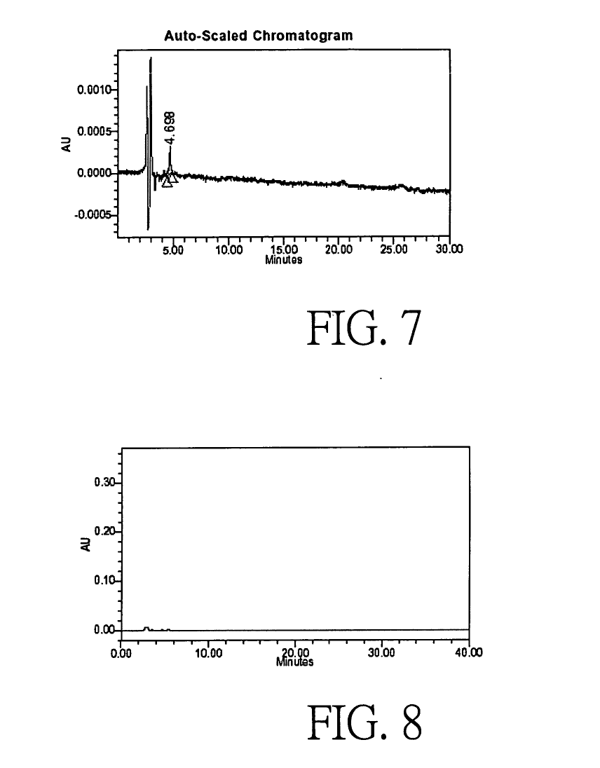

With reference to FIGS. 7 and 8, the results of the product analysis by HPLC showed no peak at 5.567 and 9.016 minutes and determined that the residual sample did not have any Alq3. The peak in FIG. 7 was produced by an impurity in the solvent.

Although the invention has been explained in relation to its preferred embodiment, that many other possible modifications and variations can be made without departing from the spirit and scope of the invention as hereinafter claimed is to be understood.

1. A melting plasma method for treatment of Alq3 organic waste comprising steps of:
(a) providing an organic waste comprising Alq3;
(b) heating the Alq3 organic waste provided in step (a) by melting plasma; and
(c) obtaining a non-toxic organic solid lava that does not have any Alq3.

2. The method as claimed in claim 1, which further comprises putting the Alq3 organic waste provided in step (a) in a reaction device and heating by melting plasma in the reaction device.

3. The method as claimed in claim 1, wherein the Alq3 organic waste is heated by melting plasma to over 1300° C.

4. The method as claimed in claim 1, wherein the Alq3 organic waste is heated by melting plasma to 1300° C. in one hour.
